(19) United States
(12) Patent Application Publication
(10) Pub. No.: US 2015/0197198 A1
(43) Pub. Date: Jul. 16, 2015

(54) VEHICLE WITH TELESCOPABLE ENTRY LADDER

(71) Applicant: SIEMENS AKTIENGESELLSCHAFT, Muenchen (DE)

(72) Inventors: Florian Egner, Icking (DE); Sven Juehling, Taucha (DE); Thomas Langenbacher, Mering (DE); Guenther Proell, Augsburg (DE)

(21) Appl. No.: 14/420,147

(22) PCT Filed: Jul. 22, 2013
(86) PCT No.: PCT/EP2013/065445

§ 371 Date: Feb. 6, 2015

(30) Foreign Application Priority Data
Aug. 8, 2012 (DE) 10 2012 214 089.1

(51) Int. Cl. B60R 3/02

(52) U.S. Cl. CPC B60R 3/02

(57) ABSTRACT

A vehicle which can be accessed in a comfortable manner includes an entry door and an entry ladder which is disposed on the vehicle below the entry door and which can be elongated, extended or lengthened at the side of the ladder facing away from the entry door. This is achieved by a drive which converts the entry ladder from a retracted position into an extended position.

The invention relates to a vehicle with an entry door and an entry ladder disposed below the entry door on the vehicle which is able to be extended on its side facing away from the entry door.

Vehicles with extendable ladders are already known from the prior art. Thus for example fire extinguishing appliances of the fire service generally have an extendable ladder which is equipped with a drive to extend the ladder to its maximum length.

In railway technology locomotives are usually equipped with entry ladders which are not extendable and are attached permanently to the side wall of the locomotive. The entry ladder makes it possible for the train driver to get into the driver's cabin even if the locomotive is parked in the open and not at a platform. The disadvantage of extendable entry ladders has proved to be that said ladders can only be extended manually with difficulty and subsequently moved back into their original position again.

The object of the invention is to provide a vehicle of the type described at the start which can be conveniently accessed, wherein the danger of accidents is minimized.

In accordance with the invention it is therefore proposed that a drive be provided, which transfers the entry ladder from a retracted position into an extended position.

Within the framework of the invention the entry ladder no longer has to be moved to and fro manually between the different positions. Instead it is possible within the framework of the invention to use a drive for this purpose, wherein the drive can be put into action for example via a suitable remote control. A user can thus cause the entry ladder to extend even in impassable terrain or with large differences in height between the ground level of the terrain and the lowest rung of the entry ladder.

In accordance with a preferred embodiment of the invention spring means are provided for holding the entry ladder in a retracted position, wherein the drive extends the entry ladder against the spring force of the spring means and wherein the spring means, in the absence of the drive, transfers the entry ladder into its retracted position. Such an embodiment of the invention has proved especially advantageous in the area of rail traffic. The background is that a so-called loading gauge profile is defined for rail traffic. The rail vehicle should not have any components which extend beyond the loading gauge profile, since otherwise accidents would be the inevitable result. In accordance with the invention the entry ladder is disposed in its retracted position within the loading gauge profile. However in the extended position the entry ladder projects beyond the loading gauge profile. In order to avoid accidents spring means are provided in accordance with the invention which are fastened in or on the entry ladder and/or the rail vehicle so that the entry ladder is transferred in the absence of the drive into its retracted position and/or is held in said position. The drive actually makes it possible to extend the entry ladder downwards. In such cases the drive must create a drive force however which overcomes the spring forces acting in opposition. The spring forces here are dimensioned so that the entry ladder can be moved between the retracted and the maximum extended position by the drive without any damage to the spring means occurring, such as for example irreversible deformations of said means or the like. Within the framework of the invention the spring means includes one or more springs.

Within the framework of the invention all expedient springs basically come into consideration as spring means. The spring means can have one or two individual springs. In such cases the spring means comprise at least one mechanical spring for example, e.g. a coil spring.

In accordance with a preferred embodiment the spring means comprise at least one gas spring. Preferably two gas springs are provided, which are disposed for example within the hollow side rails of the entry ladder.

Within the framework of the invention there can basically also be any drive. Thus the drive is an electric drive for example.

Preferably however the drive is a hydraulic and preferably a pneumatic drive. A pneumatic drive is especially advantageous in conjunction with vehicles which, as a result of the compressed air supply present in any event to the brakes of the vehicle, do not need any additional motors or the like. The invention is thus especially cost-effective if the vehicle is a rail vehicle or a truck.

Advantageously the entry ladder is a telescopable entry ladder. A telescopable entry ladder is especially space-saving. This too has also proved especially advantageous in the field of rail traffic, since the installation space, especially of locomotives, is greatly restricted.

In accordance with a further development in this context, the entry ladder has two hollow side rails lying next to one another and rungs running between the side rails, wherein at least one ladder section is provided which has two hollow profiles lying next to one another which are connected via a rung to one another in a U shape, wherein the free ends of the hollow profiles extend in each case into the assigned side rail or into the assigned hollow profile. To avoid the section falling out of the side rails or out of the other ladder sections, expedient stop shoulders and thrust bearings are embodied in the side rails and/or the hollow profiles.

Further expedient embodiments and advantages of the invention are the subject matter of the description given below of exemplary embodiments of the invention, which refer to the figures of the drawing, wherein the same reference numbers apply to components which have the same effect and wherein

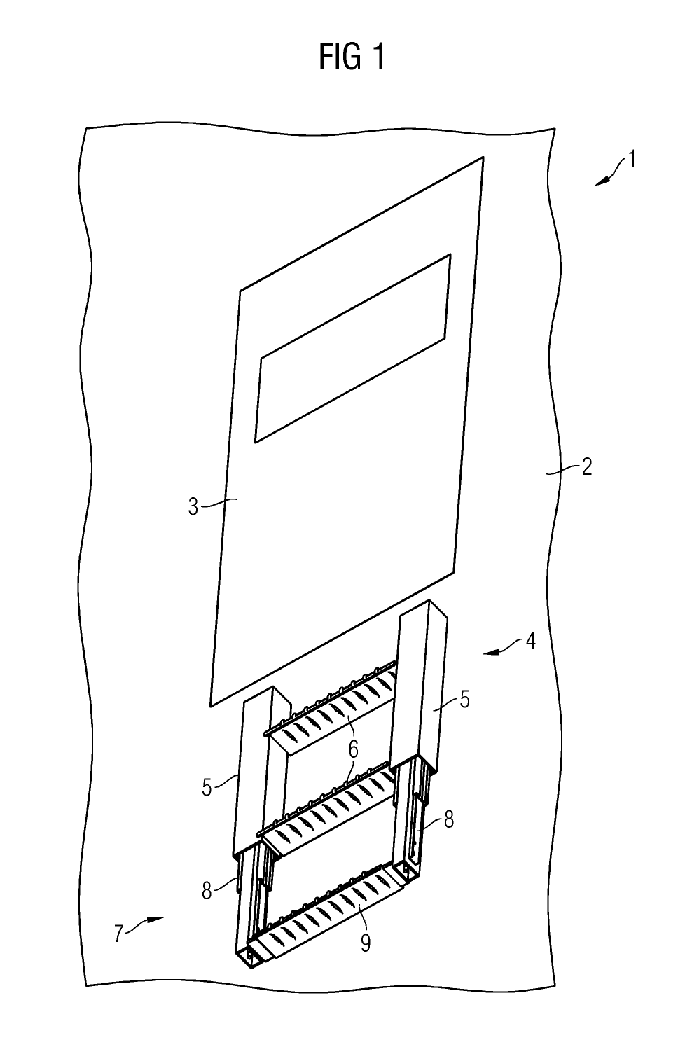

FIG. 1 shows a part view of an exemplary embodiment of the inventive rail vehicle,

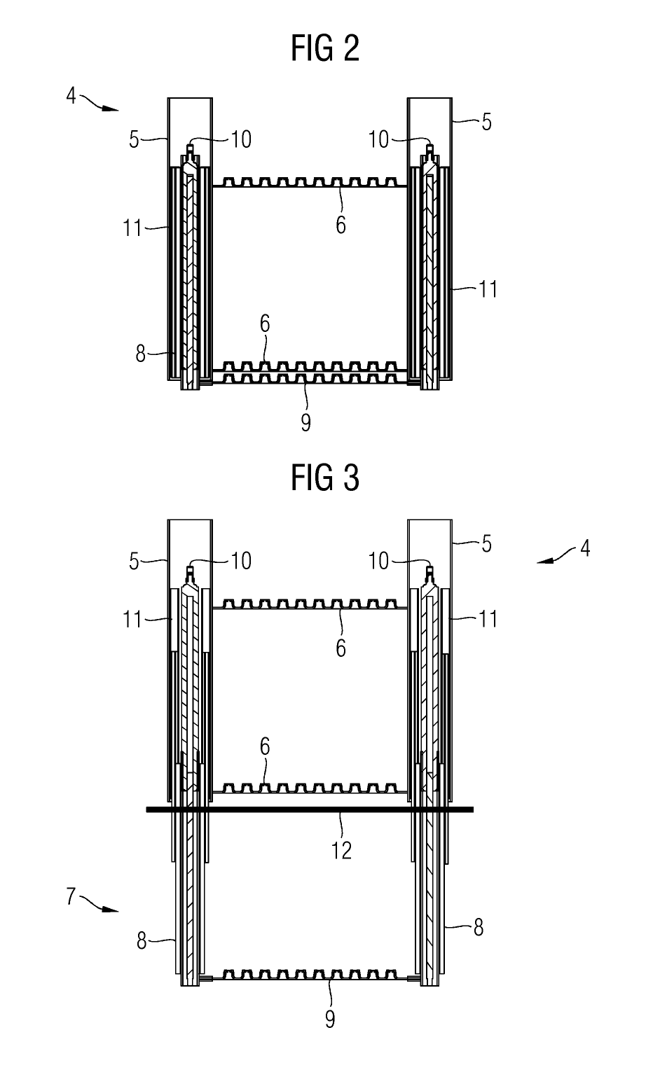

FIG. 2 shows the entry of the rail vehicle in accordance with FIG. 1 in a retracted state,

FIG. 3 shows the entry ladder in accordance with FIG. 2 in an extended state with the loading gauge profile drawn in, and

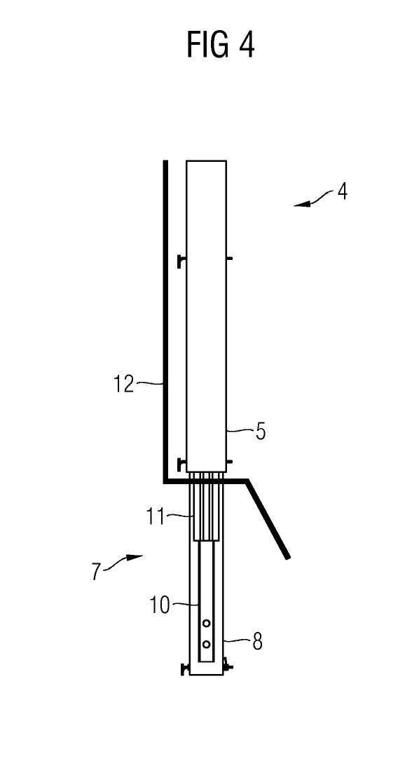

FIG. 4 shows the ladder in accordance with FIG. 3 in the extended state with the loading gauge profile drawn in.

FIG. 1 shows a part view of an exemplary embodiment of the inventive vehicle 1, which involves a rail vehicle. The rail vehicle 1 has a vehicle body of which only a part of its side wall 2 is visible. An entry door 3 is visible in the side wall 2 which leads to an inner space, here a driver's cab of a locomotive. Disposed below the vehicle door 3 is an entry ladder 4 which makes it possible for the vehicle driver, even in terrain where there is no platform, to comfortably reach the driver's cab. The entry ladder 4 is extendable and has two side rails 5 lying next to one another, with which the entry ladder 4 is fastened to the side wall 2. Rungs 6 extend between the side rails 5, essentially at right angles. Also visible is a telescopable ladder section 7, which has two hollow profiles 8 lying next to one another. The hollow profiles 8 are also connected to one another by a rung 9. The hollow profiles 8 extend with their free end, i.e. facing away from the rung 9, into one of the hollow side rails 5 in each case. The ladder section 7 is thus embodied in a U shape. Stop shoulders and thrust bearings not shown in the figure prevent the two hollow profiles 8 falling out of the side rails 5.

FIG. 2 shows the entry ladder 4 in a sectional view from the front. The entry ladder 4 is in its retracted position in FIG. 2, in which the hollow profiles 8 are arranged almost completely within the hollow side rails 5. It can further be seen that the entry ladder 4 is equipped with spring means 10 and also with a drive 11. The spring means 10 comprise two gas springs 10 which are each partly disposed in a pneumatic cylinder 11 of the drive. In this case the gas spring 10 is connected in its upper end shown in FIG. 2 with the respectively assigned side rail 5, wherein the other end of the gas spring 10 is permanently connected with the likewise permanently assigned hollow profile 8 of the ladder section 4. The pneumatic cylinder 11 is connected via a controllable drive valve to the main air container of the locomotive not shown in the figure.

In FIG. 3 the entry ladder 4 is shown in its extended position. For this the pneumatic cylinder 11 has had compressed air applied to it from the main air container, through which the gas spring 10 is extended against its spring force. Thus a pneumatic drive is provided for transferring the entry ladder 4 from the retracted position into its extended position. If the air is withdrawn from the pneumatic cylinder by means of the drive valve not shown, the gas spring 10 provides a resetting force, through which the ladder section 7 is transferred into the retracted position shown in FIG. 2.

In FIG. 4 a loading gauge profile 12 of the rail vehicle 1 is indicated by a bold line. It can be seen that the ladder section 7, in the extended position, protrudes beyond the loading gauge profile 12.

FIG. 4 shows the entry ladder 4 in accordance with FIG. 3 in a view from the side. Here too the loading gauge profile 12 is illustrated by a bold line. In accordance with the invention it is insured that, in the absence of the drive, the loading gauge profile 12 will not be exceeded by the extended entry ladder. Thus accidents are avoided within the framework of the invention.

1-7. (canceled)

8. A vehicle, comprising:
an entry door;
an entry ladder disposed on the vehicle below said entry door, said entry ladder having a side facing away from said entry door and said entry ladder being extendable and retractable on said side facing away from said entry door between an extended position and a retracted position; and
a drive converting said entry ladder from said retracted position to said extended position.

9. The vehicle according to claim 8, which further comprises a spring device having a spring force for holding said entry ladder in said retracted position, said drive extending said entry ladder against said spring force of said spring device and said spring device converting said entry ladder into said retracted position without activation of said drive.

10. The vehicle according to claim 9, wherein said spring device has at least one gas spring.

11. The vehicle according to claim 8, wherein said drive is a hydraulic or a pneumatic drive.

12. The vehicle according to claim 8, wherein said entry ladder is a telescopable entry ladder.

13. The vehicle according to claim 12, wherein said entry ladder includes:
two hollow side rails lying next to one another;
rungs running between said side rails;
a ladder section having two hollow profiles lying next to one another; and
another rung interconnecting said hollow profiles in a U shape;
said hollow profiles having free ends each disposed in a respective one of said side rails.

14. The vehicle according to claim 12, wherein said entry ladder includes:
two hollow side rails lying next to one another;
rungs running between said side rails;
at least two ladder sections each having two hollow profiles lying next to one another and another rung interconnecting said hollow profiles in a U shape;
said hollow profiles of each of said at least two ladder sections having free ends each disposed in a respective one of said side rails or in a respective one of said hollow profiles of another of said at least two ladder sections.

15. The vehicle according to claim 13, wherein:
said hollow profiles include innermost hollow profiles;
gas springs each extend between a respective one of said side rails and a respective one of said hollow profiles; and
said gas springs are each supported on one side on a respective one of said side rails and on another side on a respective one of said innermost hollow profiles.

16. The vehicle according to claim 14, wherein:
said hollow profiles include innermost hollow profiles;
gas springs each extend between a respective one of said side rails and a respective one of said hollow profiles; and
said gas springs are each supported on one side on a respective one of said side rails and on another side on a respective one of said innermost hollow profiles.
